(19) United States
(12) Patent Application Publication
(10) Pub. No.: US 2012/0298631 A1
(43) Pub. Date: Nov. 29, 2012

(54) PLASMA TORCH AND METHOD FOR STABILIZING A PLASMA TORCH

(76) Inventors: Vincent Rat, Feytiat (FR); Jean Françoís Coudert, Limoges (FR)

(21) Appl. No.: 13/510,212

(22) PCT Filed: Nov. 12, 2010
(86) PCT No.: PCT/FR2010/000753

§ 371 Date: Jul. 17, 2012

(30) Foreign Application Priority Data
Nov. 17, 2009 (FR) 0905512

(51) Int. Cl. H05H 1/26

(52) U.S. Cl. 219/121.5; 219/121.59

(57) ABSTRACT

The invention relates to a nontransferred arc plasma torch comprising: a tubular torch body (10); at least one cathode (20) placed inside said torch body and defining a so-called cathode cavity (50); and at least one tubular anode (30) also placed inside the torch body and forming a plasma ejection nozzle. Said torch is characterized in that the torch also comprises a means (100) for minimizing the resonant pressure waves in said or each cathode cavity. The invention also relates to a method for stabilizing a plasma torch by means of acoustic coupling of the cathode cavity thereof to at least one acoustic oscillator. The invention moreover relates to the use of a thus-stabilized torch for surface coating deposition.

The invention relates to a blown-arc plasma torch, in particular intended to be used to carry out a process for coating a surface by plasma spraying. The invention also relates to a method for stabilizing such a plasma torch.

Plasma spraying is a technique that allows surface coatings to be produced by injecting, into a plasma jet, materials that may take the form of a powder, liquid or that of a suspension containing a liquid and a powder. These materials are treated by the plasma and then sprayed onto a surface where they form a deposit the properties of which depend on the operating conditions and on the stability of the plasma torch generating the jet.

The torches generally used to carry out such a process are “blown-arc” torches. They comprise a rod-type hot cathode, functioning via thermionic emission, with a conical end or a button-type cathode, mounted coaxially with a cylindrical hollow anode forming a nozzle for ejecting gases, without electrical contact, by virtue of an insulating tubular holder that forms the torch body. Cold cathodes, for example well-type cathodes (“Aérospatiale” torches) may also be used. These torches are generally used to incinerate waste and not to produce surface coatings, but arc instability is also a problem in this case.

In any case, the plasma gas is made to flow into a region known as the “cathode cavity” before being converted into a plasma. As its name indicates, the cathode cavity is an essentially enclosed region (having a gas inlet and outlet, however) and at least partially bounded by the cathode. For example, in a rod-type hot cathode torch, the cathode cavity consists of the space extending from the orifice for injecting the plasma gas to the tip of the cathode. In an “Aérospatiale” torch the cathode cavity consists of the interior of the hollow cathode (it will be noted that in this case the cathode cavity encompasses part of the arc but that only a small fraction of the gas contained in this cavity is ionized inside the cavity).

After a DC electric arc has been struck between the cathode and the anode, a current source ensures that an electrical current passes through the ionized plasma gas. An electric arc, confined between the cathode and the anode, is thus established. The electrical power dissipated in the plasma gas allows a plasma jet to be generated, into which the materials to be treated are injected. This electrical power depends on the voltage between the cathode and the anode.

For a general introduction to plasma torches, especially blown-arc plasma torches, the reader is referred to the article by Pierre Fauchais “Plasmas thermiques: production” (Thermal plasmas: production), Techniques de l'Ingénieur, paper D 2 820v2.

It is known that blown-arc plasma torches are the site of substantial instability in the electric arc, which should be limited in order to obtain uniform and stable treatment of the materials injected into the plasma jet. Specifically, the electric arc is unstable: the position of its attachment to the anode wall (and cathode wall, in the case of “Aérospatiale” torches comprising a hollow cathode) varies over time, therefore varying its length. As a result thereof, the (anode-cathode) voltage of the torch, and, consequently, the instantaneous electrical power dissipated in the plasma gas, also varies, thereby leading to a nonuniform treatment of the materials injected into this gas. Experimental studies have shown that the velocities and temperatures of solid particles injected into the plasma jet follow the torch voltage fluctuations and vary significantly. It has also been demonstrated that suspensions are subjected to a highly unstable treatment because of the fluctuating plasma jet, which has a direct influence on the properties of the coatings. This effect is particularly detrimental in the case of coating processes employing submicron-size solid particles.

To limit the amplitude of the longitudinal movement of the electric arc over the anode wall, and therefore the voltage of the torch, electrically insulated rings (“neutrodes”) may be inserted into the anode forcing the arc to attach itself to the anode wall further downstream. These modifications may be applied to single-cathode or three-cathode torches. See, in this regard:
the article by M. Vilotijevic et al. “Velocity and texture of a plasma jet created in a plasma torch with fixed minimal arc length”, Plasma Sources Sci. Technol. 18 (2009) 015016; and
document U.S. Pat. No. 5,406,046.

In the case of single-cathode torches with neutrodes, the voltage variation amplitude is decreased but the average voltage is increased, thereby causing a substantial increase in the electrical power consumed. Moreover, since the attachment region of the electric arc is smaller, the arc current must not be too high in order to limit the rate of erosion of the anodes.

It is also possible to use a magnetic field applied at the arc root in order to more effectively distribute its thermal impact over the anode wall, as for example in the case of torches with well-type cathodes and vortex injection (EP0277845). The complexity of the system is proportionally increased, likewise that of its maintenance.

In the case of three-cathode torches (U.S. Pat. No. 5,406,046), the presence of neutrodes also allows the arc voltage variation amplitude to be limited. However, the three cathodes generate three electric arcs, each having a smaller current than for single-cathode torches, which create three plasma jets. The erosion of the electrodes is then significantly reduced. The drawback is that plasma gases are injected with a nonzero azimuthal velocity component (swirl injection), which induces a variation in the position of the plasma jets. Their spatial distribution depends on the, sometimes unstable, operating conditions and it is therefore necessary to systematically match the injection of materials with the plasma jets. To alleviate these drawbacks, complex anodes have been developed in order to prevent variation in the attachment sites of the three arcs to the anode wall: see in this regard document U.S. Pat. No. 7,030,336.

The internal geometry of the torch may also be modified by adding a “hot” anode, which allows the amplitude of fluctuations in the arc root to be limited, and by shielding the plasma jet with an inert gas, allowing premature mixing of the plasma with ambient gas to be limited—see in this regard document U.S. Pat. No. 5,220,150.

All these solutions cause a significant increase in the complexity of the plasma torches.

The invention aims to provide a solution to the problem of instability in blown-arc plasma torches, which solution does not have the aforementioned drawbacks of prior-art techniques.

Whereas most research on the origin of instabilities in blown-arc plasma torches has focused on a magnetohydrodynamic model of the behavior of the electric arc (S. A. Wutzke et al. “Study of electric-arc behavior with superimposed flow” AIAA J., 5, 707 (1967); J. P. Trelles et al. “Non-equilibrium modeling of arc plasma torches” J. Phys. D: Appl. Phys. 40 (2007) 5937-5952), the present invention employs a mechanical, and more precisely acoustic, effect.

Recent studies have shown that the movement of the electric arc is coupled to pressure oscillations in the cold plasma gas in the cathode cavity (upstream part of the torch):
J. F. Coudert, V. Rat, D. Rigot “Influence of Helmholtz oscillations on arc fluctuations in a dc plasma spraying torch”, J. Phys. D: Appl. Phys. 40 (2007) 7357-7366; and
J. F. Coudert, V. Rat “Influence of configuration and operating conditions on the electric arc instabilities of a plasma spray torch: role of acoustic resonance”, J. Phys. D: Appl. Phys. 41 (2008) 205208.

However, these publications do not establish a causal link between pressure oscillations and electrical instabilities inside the torch, and do not suggest a technique for stabilizing plasma torches employing this coupling.

The present inventors have demonstrated that attenuation or suppression of certain resonant pressure waves in said cathode cavity (Helmholtz oscillations) allow a very substantial reduction in the instability of the electric arc. Thus, one subject of the invention is a blown-arc plasma torch comprising:
a tubular torch body;
at least one cathode located inside said torch body and bounding a cavity called the cathode cavity; and
at least one tubular anode, also located inside the torch body, forming a nozzle for ejecting the plasma,

characterized in that the plasma torch also comprises a means for attenuating resonant pressure waves in said or each cathode cavity.

The pressure waves may be actively attenuated, using a detector of said waves and an actuator generating oscillations in phase opposition. The waves may be directly detected, by means of a pressure sensor, or indirectly, by measuring the arc voltage or the luminosity of the arc. The acoustic phase conjugation technique may also be used. However, these techniques are difficult to implement. This is why, in a preferred embodiment of the invention, said means for attenuating resonant pressure waves in the cathode cavity may comprise at least one acoustic resonator opening onto the cathode cavity.

An acoustic resonator allows a set of oscillation modes to be attenuated. However, if a number of these mode sets significantly contribute to the instability of the electric arc, it is possible to provide a plurality of said acoustic resonators tuned or tunable to different resonant frequencies.

Said or each acoustic resonator may consist of a secondary cavity connected to the cathode cavity via a neck. The experiments carried out by the inventors have shown that, at least in certain cases, the secondary cavity may have a very small depth, of about 1.5 mm. In such a case, said secondary cavity may be formed by a void or hole in a wall of said torch body. Thus, a torch according to the invention may be produced from an existing torch, for example a commercially available torch, simply by producing such a void or hole.

Advantageously, said or each acoustic resonator may comprise a means for tuning its resonant frequency. This is because, the optimal resonant frequency (allowing the best stabilization of the electric arc) does not depend only on the geometry of the torch, but also on the chemical composition of the cold plasma gas and the operating conditions (gas pressure and flow rate, electrical current, etc.). When the secondary cavity of the acoustic resonator is formed by a void or hole in a wall of the torch body, said tuning means may comprise a simple adjustment screw, provided inside said secondary cavity.

The frequency tuning may be carried out manually or automatically. In the second case, the torch may comprise a means for controlling said or each tuning means depending on the voltage measured between the anode and the cathode.

Advantageously, the cathode of the torch may be an elongate hot cathode extending over part of the length of the torch body; the anode may at least partially surround said cathode; and the cathode cavity may be bounded by the cathode and by the interior surface of the torch body.

Another subject of the invention is a method for stabilizing a plasma torch comprising:
a tubular torch body;
at least one cathode located inside said torch body and bounding a cavity called the cathode cavity; and
at least one tubular anode, also located inside the torch body, forming a nozzle for ejecting the plasma,

by acoustically coupling said or each cathode cavity to at least one acoustic oscillator.

According to various embodiments of the invention, such a method may also comprise a step of tuning the resonant frequency of said or each acoustic oscillator so as to:
either minimize the amplitude of oscillations in the voltage between the anode and the cathode;
or maximize the voltage between the anode and the cathode,

when an electric arc is established between them.

Advantageously, said or each cathode of the torch to be stabilized may be an elongate hot cathode extending over part of the length of the torch body; said or each anode may at least partially surround said cathode or a said cathode; and said or each cathode cavity may be bounded by said or one said cathode and by the interior surface of the torch body.

Yet another subject of the invention is the use of a torch such as described above to deposit surface coatings.

Other features, details and advantages of the invention will become clear on reading the description given with reference to the appended drawings provided by way of example and that respectively show:

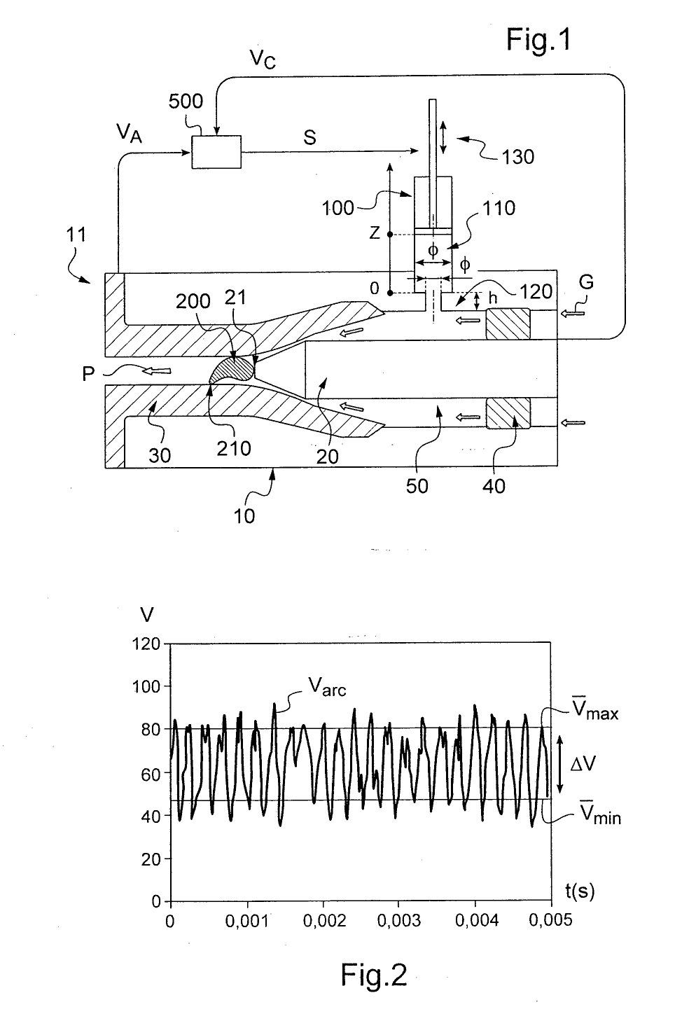

FIG. 1, a simplified cross-sectional view of a blown-arc plasma torch according to a first embodiment of the invention, in which the frequency of the acoustic resonator is tuned using a piston;

FIG. 2, a graph of the voltage signal between the anode and the cathode of a conventional blown-arc plasma torch;

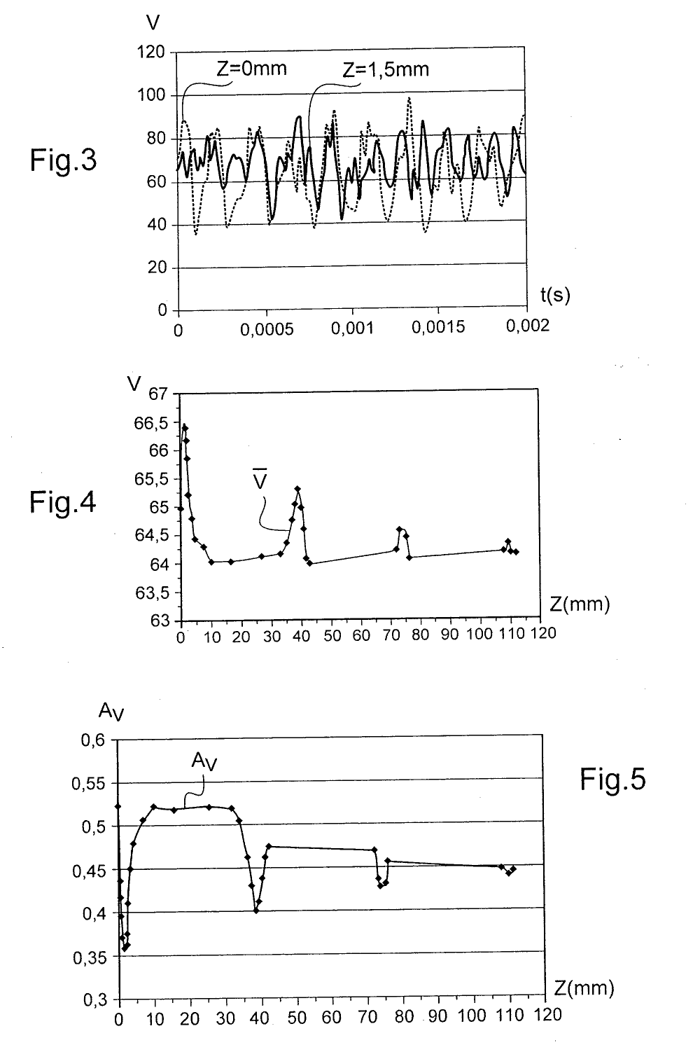

FIG. 3, a graph of the voltage signal between the anode and the cathode of the torch in FIG. 1, for two values of the “z” position of the piston;

FIG. 4, a graph of the average arc voltage in the torch of FIG. 1, as a function of the “z” position of the piston;

FIG. 5, a graph of the stability coefficient of the torch in FIG. 1, as a function of the “z” position of the piston;

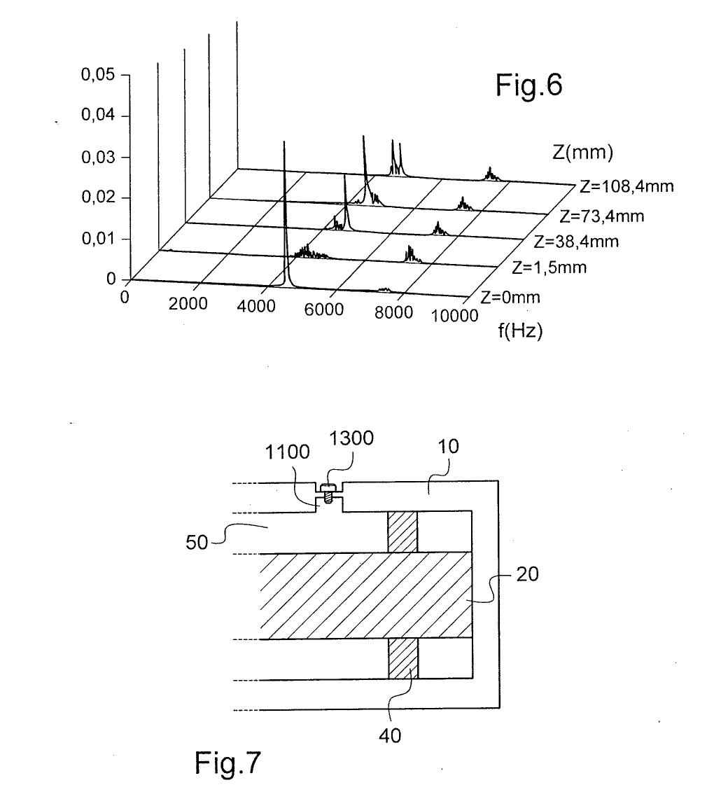

FIG. 6, a graph showing the variation of the power spectrum of the arc voltage in the torch in FIG. 1 as a function of the “z” position of the piston; and

FIG. 7, a detail view of a torch according to a second embodiment of the invention.

FIG. 1 shows a simplified cross-sectional view of a blown-arc plasma torch with a rod-type hot cathode, comprising:
a tubular torch body 10 at least partially made from an electrically insulating material; the interior of the torch body is cylindrical in its upstream part (where the plasma gas G is injected), then, in its downstream part has a nozzle shape with an outlet 11;
an elongate cathode 20, extending inside the torch body over part of its length, and having a conical tip 21 at its end; and
an anode 30, which is also tubular, partially surrounding the cathode 20 and extending beyond the tip 21 of the latter in the direction of the outlet 11, and thus forming a nozzle for ejecting the plasma. The anode and cathode are electrically isolated from each other.

The region lying between the cathode 20 and the internal wall of the torch body 10 forms an annular “cathode cavity”. This cavity is axially bounded:
downstream, by the narrowing of the torch body that occurs at the tip of the cathode; and
upstream, by the “injection ring” 40, which allows the cold plasma gas G to be injected into the cathode cavity.

The reference 200 indicates the electric arc that is generated between the tip 21 of the cathode, and the anode 20; the reference 210 indicates the “root” of the arc, i.e. the point of contact between the arc and the anode. It is the movement of this “root”, and its detachments from and reattachments to the anode surface that are the origin of the instabilities that the present invention aims to prevent.

Downstream of the arc 200, the flow of plasma gas G is converted into a plasma jet P.

A cylindrical acoustic resonator 100 is coupled to the cathode cavity 50. This resonator comprises a chamber, or secondary cavity, 110, of diameter φ₁ and height z, and a neck 120 of diameter φ₂≦φ₁ and height h. The height z of the chamber 110, and therefore the resonant frequency of the resonator, may be adjusted by moving a piston 130, for example using an electric motor, a piezoelectric actuator, or simply by manual adjustment.

In an exemplary embodiment of the invention:
the cathode cavity has an overall circular shape 16 mm in length with a (maximum) outside diameter of 21 mm and (maximum) inside diameter of 14 mm;
h=6 mm;
φ₁=10 mm;
φ₂=5 mm; and
z=0-120 mm.

The diameter of the anode (downstream of the tip 21) is 6 mm. The torch is supplied with an argon/hydrogen mixture with respective flow rates of 45 and 10 slpm (standard liters—at 20° C., 1 atmosphere—per minute). The arc current is 500 A.

FIG. 2 shows a graph of the arc voltage V_{arc}, i.e. the voltage measured between the anode and the cathode, as a function of time t (in seconds) for a torch similar to that in FIG. 1 but not comprising an acoustic resonator. It may be seen that the voltage fluctuates between about 40 and 90 V, with an average value V̅ of about 60 V. In the figure, V̅ₘₐₓ represents the average of the voltage maxima above the average value V̅ and V̅ₘᵢₙ the average of the voltage minima below said average value V̅.

The algorithm used to detect the maxima (or minima) consists in successively fitting a parabola to three points of the measured signal, finding whether the parabola is located at a local maximum (or a local minimum) and determining the sign of the quadratic coefficient in order to obtain the concavity (maximum or minimum).

The average voltage amplitude, ΔV, is defined as:

ΔV= V̅ₘₐₓ− V̅ₘᵢₙ

The stability coefficient, A_{V}, is also defined:

$${A}_{V} = \frac{Δ V}{\overline{V}}$$

If the coefficient A_{V} is decreased, the stability of the torch is increased.

FIG. 3 shows, on a time scale that has been magnified relative to that in FIG. 2, the voltage signals of the torch in FIG. 1 for two z (height of the chamber of the resonator) values: z=0, corresponding to an inactive resonator, and z=1.5 mm. It may be seen that the oscillations in the voltage signal are less substantial for z=1.5 mm, which shows already that the presence of the resonator has a positive effect on the stability of the torch.

FIG. 4 shows a graph of the average arc voltage V̅ for various z positions of the resonator. It may be seen that the average voltage varies as a function of z and possesses several maxima for z=1.5, 38.4, 73.4 and 108.4 mm, the highest maximum corresponding to z=1.5 mm.

The presence of the acoustic resonator therefore modifies the average voltage of the torch.

FIG. 5 shows a graph of the stability coefficient A_{V} as a function of z under the same experimental conditions as FIG. 5. Several minima are observed, which coincide with the voltage maxima, the lowest minimum (corresponding to the conditions of greatest stability) being obtained for z=1.5 mm.

The condition z=1.5 mm corresponds to the first oscillation mode of the resonator, which may therefore be modeled as a Helmholtz resonator.

The stability coefficient varies from 0.52, when the resonator is inactive (z=0), to 0.36 for z=1.5 mm, i.e. a reduction of 30%. The stability of the torch is therefore increased by about 30%.

The observed correlation between the graphs of V̅ and A_{V} show that, to optimally stabilize the torch, it is possible to tune the resonator 100 either directly by minimizing A_{V} or, more simply, by maximizing V̅. The optimal z position (which may vary in time, if the operating conditions change) may be manually or automatically adjusted using conventional techniques. By way of example, FIG. 1 schematically shows a control means 500 (for example a suitably programmed computer or a dedicated circuit board) receiving as input signals V_{A}, V_{C} indicative of the voltage levels of the anode and cathode, respectively, and generating a signal “s” for controlling the piston 130.

FIG. 6 shows the normalized power spectra for z=0, 1.5, 38.4, 73.4, and 108.4 mm. The power spectrum for z=0 shows a main peak at about 4550 Hz, which is a result of the mechanical resonance effect between the electric arc and the cold plasma gas in the cathode cavity.

When z=1.5 mm, the amplitude of the main resonant peak at 4550 Hz is greatly decreased. A reduction is also observed for z=38.4, 73.4 and 108.4 mm, but it is less marked. The resonance effect is therefore greatly inhibited by the action of the acoustic resonator, and the stability of the torch is improved.

The fact that the best stabilization of the torch is obtained for the first resonance (z=1.5 mm) allows a plasma torch produced according to the invention to be made simpler. This is because, as FIG. 7 shows, the cavity of the acoustic resonator may be produced very simply in the form of a void or hole 1100 in the internal wall of the torch body 10. Frequency tuning may be ensured by a simple adjustment screw 1300.

The invention has been described with reference to the particular case of torches with a rod-type hot cathode. This is not a fundamental limitation: specifically, all blown-arc torches have at least one cathode cavity in which standing pressure waves are excited. As in the case of torches with a rod-type hot cathode, these pressure waves contribute to the instability of the arc current and may be attenuated by means of an acoustic resonator coupled with the cathode cavity.

In torches comprising a plurality of cathodes and/or anodes, and therefore a plurality of cathode cavities, an acoustic resonator will advantageously be provided for each cavity.

1. A blown-arc plasma torch comprising:
a tubular torch body;
at least one cathode located inside said torch body and bounding at least one cavity called the cathode cavity (50); and
at least one tubular anode, also located inside the torch body, forming a nozzle for ejecting the plasma,
wherein the plasma torch also comprises a means for attenuating resonant pressure waves in said or each cathode cavity, comprising at least one acoustic resonator opening onto the cathode cavity.

2. The plasma torch as claimed in claim 1, comprising a plurality of said acoustic resonators tuned or tunable to different resonant frequencies.

3. The plasma torch as claimed in claim 1, in which said or each acoustic resonator consists of a secondary cavity connected to the cathode cavity via a neck.

4. The plasma torch as claimed in claim 3, in which said secondary cavity is formed by a void or hole in a wall of said torch body.

5. The plasma torch as claimed in claim 1, in which said or each acoustic resonator comprises a means for tuning its resonant frequency.

6. The plasma torch as claimed in claim 4, in which said tuning means comprises an adjustment screw provided inside said secondary cavity.

7. The plasma torch as claimed in claim 5, comprising a means for controlling said or each tuning means depending on the voltage measured between the anode and the cathode.

8. The plasma torch as claimed in claim 1, in which:
said or each cathode is an elongate hot cathode extending over part of the length of the torch body;
said or each anode at least partially surrounds said cathode or a said cathode; and
said or each cathode cavity is bounded by said or one said cathode and by the interior surface of the torch body.

9. A method for stabilizing a plasma torch comprising:
a tubular torch body;
at least one cathode located inside said torch body and bounding a cavity called the cathode cavity; and
at least one tubular anode, also located inside the torch body, forming a nozzle for ejecting the plasma,
by acoustically coupling said or each cathode cavity with a means for attenuating resonant pressure waves in the cathode cavity, comprising at least one acoustic resonator.

10. The method as claimed in claim 9, also comprising a step of tuning the resonant frequency of said or each acoustic resonator so as to minimize the amplitude of oscillations in the voltage between the anode and the cathode when an electric arc is established between them.

11. The method as claimed in claim 9, also comprising a step of tuning the resonant frequency of said or each acoustic resonator so as to maximize the voltage between the anode and the cathode when an electric arc is established between them.

12. The method as claimed in claim 9, in which:
said or each cathode of the torch is an elongate hot cathode extending over part of the length of the torch body;
said or each anode at least partially surrounds said cathode or a cathode; and
said or each cathode cavity is bounded by said or one said cathode and by the interior surface of the torch body.

13. (canceled)
